(19) United States
(12) Patent Application Publication
(10) Pub. No.: US 2004/0089715 A1
(43) Pub. Date: May 13, 2004

(54) Portable, stand-alone, shelf-mounted promotional device

(76) Inventor: Jon Otis, Long Branch, NJ (US)

Correspondence Address: Kirschstein, Ottinger,, Israel & Schiffmiller, P.C., 489 Fifth Avenue, New York, NY, 10017-6105, US

(21) Appl. No.: 10/289,983

(22) Filed: Nov. 7, 2002

(51) Int. Cl. G06K 15/00

(52) U.S. Cl. 235/383

(57) ABSTRACT

A stand-alone, promotional device is suspended from a lip of a shelf in a display rack to attract a consumer's attention to merchandise on the shelf.

### BACKGROUND OF THE INVENTION

1. Field of the Invention

The present invention generally relates to merchandise display racks having shelves for access to and display of merchandise and, more particularly, to promotional devices for attracting a customer's attention to such shelf-mounted merchandise.

2. Description of the Related Art

Merchandise is often displayed on shelves in display racks at retail sites. Items stored on the top and bottom shelves of a rack, or at the rear of the shelves, are often not readily accessible to, and are at least partially hidden from the view of, the average consumer. To promote accessibility and display, some racks utilize tilted shelves on which to present the items. The tilted shelves typically have raised front edges to prevent the items from sliding off the tilted shelves.

As advantageous as these known display racks are, retailers often promote their items to increase sales. Signs and animated advertising fixtures are prevalent. Often such promotional devices have components which require electrical energy and, hence, are hard-wired or plugged into electrical outlets. This results in a permanent installation, that is, one not readily movable to a different shelf, rack or location at the retail site.

### SUMMARY OF THE INVENTION

### Objects of the Invention

Accordingly, it is a general object of this invention to readily move a stand-alone, promotional device for attracting a consumer's attention to shelf-mounted merchandise.

More particularly, it is an object of the present invention to reliably hold the promotional device in position on a shelf, including a tilted shelf.

Still another object of the present invention is to more readily attract a consumer to merchandise, especially positioned in less accessible locations on a display rack.

### Features of the Invention

In keeping with the above objects and others which will become apparent hereinafter, one feature of the present invention resides, briefly stated, in a portable, stand-alone, promotional device for ready mounting on, and removal from, a support, especially a shelf having a raised front edge or lip. The shelf may be horizontal or tilted relative to the floor.

The device includes a housing, an electrically energizable, sensory indicator supported by the housing and operable for attracting attention when energized, a battery supported by the housing and electrically connected to the indicator for energizing the same, and a flange on the housing for suspending the housing, the indicator and the battery from the support. Preferably, the indicator includes a set of flashing lights, especially light emitting diodes, which draw little electrical current.

In the case of a horizontal shelf having a vertical lip, the flange is preferably a right-angled hook. In the case of a tilted shelf having an inclined lip, the flange is similarly inclined and hooks onto the lip. The indicator is preferably mounted on a front wall of the housing and, once the flange is hooked onto the lip, the front wall may either lie in a vertical plane or in an inclined plane, and faces a consumer to attract his or her attention.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of one embodiment of a device according to this invention mounted on a tilted shelf shown in a cut-away, sectional view;

FIG. 2 is a sectional view taken on line 2-2 of FIG. 1;

FIG. 3 is a side elevational view of the embodiment of FIG. 1 mounted on a tilted shelf with a different tilt angle;

FIG. 4 is a front elevational view taken on line 4-4 of FIG. 3; and

FIG. 5 is a perspective view of another embodiment of a device according to this invention mounted on a horizontal shelf.

### DETAILED DESCRIPTION OF THE PREFERRED EMBODIMENTS

Referring now to the drawings, reference numeral 10 generally identifies a portable, stand-alone, promotional device in accordance with this invention for ready mounting on, and removal from, a support, such as a planar shelf 12 having a raised, planar, front edge or lip 14. The shelf may be tilted at various tilt angles (FIGS. 1-4), or horizontal (FIG. 5), relative to the floor. The lip, preferably but not necessarily, forms a right angle relative to the respective shelf. The shelf is part of a display rack which preferably has a plurality of such shelves stacked in mutual parallelism, one above another. Merchandise is supported by the shelves for display to a consumer. The promotional device 10 is, as described below, suspended from the shelf and is operative to attract the attention of the consumer to the merchandise on display.

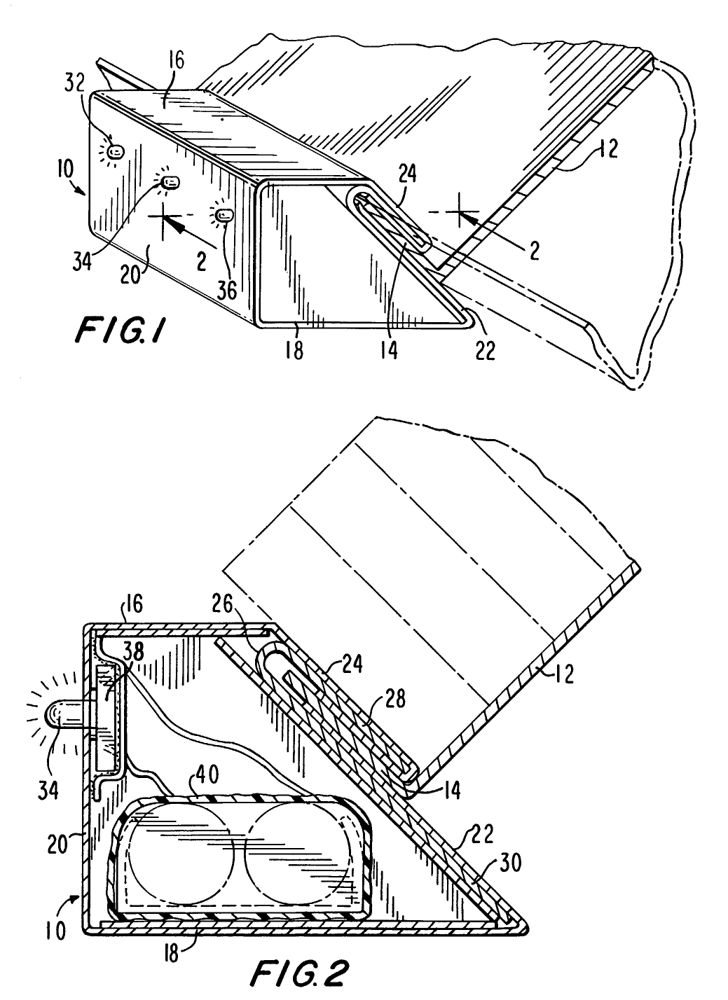

As shown in FIG. 2, the promotional device 10 includes a housing having a planar top wall 16, a planar bottom wall 18 parallel to the top wall, a planar front wall 20 extending perpendicularly to the top and bottom walls, and a planar inclined rear wall 22 between the top and bottom walls. The housing has a right trapezoidal cross-section.

A planar flange 24 is integral with the top wall of the housing and preferably is double-walled. The flange 24 is inclined and has an acute angle of depression relative to the top wall. The flange 24 also forms an acute angle with the rear wall. A U-shaped stiffener 26 strengthens the flange and includes a first stiffening portion 28 located and adhered in the space between the double walls of the flange, and a second stiffening portion 30 adhered to an interior surface of the rear wall. The stiffener is constituted of a material, for example, metal, which is more rigid than the material, for example, paper, constituting the housing. The metal stiffener is preferably bendable, and the paper used for the housing is preferably a heavyweight paper or cardboard.

An electrically energizable, sensory indicator is supported by the housing and includes, for example, a plurality of light sources 32, 34, 36 extending through apertures in the front wall, and a controller 38 for energizing the sources. A battery pack 40 is mounted within the housing, preferably on the bottom wall, and is connected to the controller for powering the same and causing the sources to emit light in a control pattern. Preferably, the sources are switched on and off and flash in a random or predetermined pattern. The flashing is performed continuously, that is, as long as the battery pack is connected. If desired, an on/off switch can be provided. To minimize power drain on the battery pack, the sources are light emitting diodes which are pulsed at a low duty cycle.

Sensory indicators, other than lights, can be used. For example, an annunciator can be employed to emit sounds from a speaker, or an oil-or wax-based, aroma emitter can be used to emit scents.

In use, the device 10 is suspended by its flange on the lip anywhere lengthwise of the lip on any selected shelf. A plurality of devices 10 can be suspended on the same shelf, or on different shelves. The battery pack, being the heaviest component, presses the flange onto the lip for a more secure anchorage. No screws, adhesives or analogous fasteners are employed. Each suspended device remains in place by gravity and the frictional engagement between the flange and the lip.

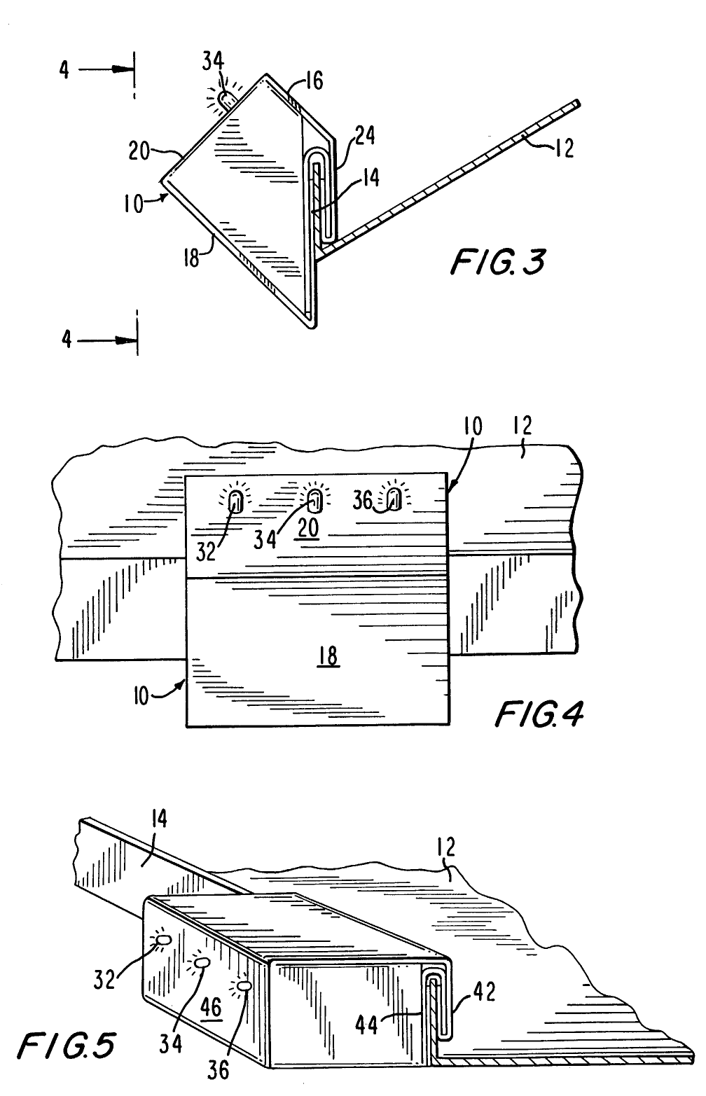

In one embodiment, as illustrated in FIGS. 1-2, the front wall 20 lies in a vertical plane. As shown in FIGS. 3-4, the front wall 20 lies in a rearwardly inclined plane to better be viewed by a consumer when the device is suspended from a low shelf. The positioning of the front wall depends on the angle of depression selected for the flange which, in turn, is dependent on the angle of the lip.

For a horizontal shelf having a vertical lip, as depicted in FIG. 5, the housing has a generally rectangular cross-section, and the flange 42 is parallel to the rear wall 44 which, in turn, is parallel to the front wall 46. As before, the housing is detachably mounted on the lip and securely held in place.

It will be understood that each of the elements described above, or two or more together, also may find a useful application in other types of constructions differing from the types described above.

While the invention has been illustrated and described as embodied in a portable, stand-alone, shelf-mounted promotional device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A portable, stand-alone, promotional device for ready mounting on, and removal from, a support, the device comprising:
a) a housing;
b) an electrically energizable, sensory indicator supported by the housing, for attracting attention when energized;
c) a battery supported by the housing and electrically connected to the indicator for energizing the indicator; and
d) a flange on the housing, for suspending the housing, the indicator and the battery from the support.

2. The device of claim 1, wherein the indicator includes a plurality of light sources on a front wall of the housing.

3. The device of claim 2, and further comprising a controller connected to the battery and the light sources, for energizing the light sources to emit light in a control pattern.

4. The device of claim 3, wherein the controller automatically switches the light sources on and off to make the light sources flash.

5. The device of claim 1, wherein the battery has a weight and is located within the housing below the flange to press the flange against the support due to the weight of the battery.

6. The device of claim 1, wherein the housing has a planar front wall on which the indicator is mounted, and wherein the flange suspends the front wall to lie in a vertical plane.

7. The device of claim 1, wherein the housing is constituted of a paper material, and wherein the flange includes a stiffener of a stiff material stronger than the paper material.

8. A portable, stand-alone, promotional device for ready mounting on, and removal from, a shelf having a raised edge, the device comprising:
a) a housing;
b) an electrically energizable, sensory indicator supported by the housing, for attracting attention when energized;
c) a battery supported by the housing and electrically connected to the indicator for energizing the indicator; and
d) a flange on the housing, for suspending the housing, the indicator and the battery from the raised edge of the shelf.

9. The device of claim 8, wherein the housing has a planar front wall on which the indicator is mounted, a planar top wall and a planar bottom wall in mutual parallelism and between which the front wall extends, and an inclined planar rear wall extending between the top and bottom walls at an acute angle of elevation relative to the bottom wall.

10. The device of claim 9, wherein the flange includes a planar suspension portion integral with the top wall, and a stiffener having a stiffening portion in surface area contact with the suspension portion.
